(19) United States
(12) Patent Application Publication
(10) Pub. No.: US 2025/0146847 A1
(43) Pub. Date: May 8, 2025

(54) CONTROL METHOD AND DEVICE, AERIAL VEHICLE, MOVABLE PLATFORM, AND STORAGE MEDIUM

(71) Applicant: SZ DJI TECHNOLOGY CO., LTD., Shenzhen (CN)

(72) Inventors: Bo WU, Shenzhen (CN); Siqi LIU, Shenzhen (CN); Yiteng XU, Shenzhen (CN)

(21) Appl. No.: 19/020,678

(22) Filed: Jan. 14, 2025

Related U.S. Application Data
(63) Continuation of application No. PCT/CN2023/082913, filed on Mar. 21, 2023.

(30) Foreign Application Priority Data
Jul. 29, 2022 (WO) PCT/CN2022/109265

(51) Int. Cl. G01D 18/00; G05D 1/243; G05D 109/25; G05D 111/10; G06T 7/80

(52) U.S. Cl. CPC G01D 18/00; G05D 1/243; G06T 7/80; G05D 2109/254; G05D 2111/10

(57) ABSTRACT

A control method includes obtaining, in real time during operation of a movable platform, data of a plurality of sensors located at one or more arm assemblies of the movable platform, performing real-time calibration using the data to obtain a calibration result that characterizes a relative pose between the plurality of sensors, and performing movement control on the movable platform according to the calibration result.

### CROSS-REFERENCE TO RELATED APPLICATIONS

This application is a continuation of International Application No. PCT/CN2023/082913, filed on Mar. 21, 2023, which claims priority to PCT/CN2022/109265, filed on Jul. 29, 2022, the entire contents of both of which are incorporated herein by reference.

### TECHNICAL FIELD

The present disclosure generally relates to the field of control technology and, more particularly, to a control method and device, an aerial vehicle, a movable platform, and a storage medium.

### BACKGROUND

A movable platform can transform to switch between multiple states to match different functions, such as expanding the photographing range, changing the working mode, etc. The movable platform can perform transformation operations through arms in one transformation mode. Since the arms of the movable platform move relative to a center body and the shape changes significantly, the control problem of the movable platform performing the transformation operations during operation still needs to be solved.

### SUMMARY

In accordance with the disclosure, there is provided a control method including obtaining, in real time during operation of a movable platform, data of a plurality of sensors located at one or more arm assemblies of the movable platform, performing real-time calibration using the data to obtain a calibration result that characterizes a relative pose between the plurality of sensors, and performing movement control on the movable platform according to the calibration result.

Also in accordance with the disclosure, there is provided a control device including one or more memories storing one or more computer programs, and one or more processors configured to execute the one or more computer programs to obtain, in real time during operation of a movable platform, data of a plurality of sensors located at one or more arm assemblies of the movable platform, perform real-time calibration using the data to obtain a calibration result that characterizes a relative pose between the plurality of sensors, and perform movement control on the movable platform according to the calibration result.

Also in accordance with the disclosure, there is provided an aerial vehicle including one or more arm assemblies, a plurality of sensors located at the one or more arm assemblies, and a control device. The control device includes one or more memories storing one or more computer programs, and one or more processors configured to execute the one or more computer programs to obtain, in real time during operation of the movable platform, data of the plurality of sensors, perform real-time calibration using the data to obtain a calibration result that characterizes a relative pose between the plurality of sensors, and perform movement control on the movable platform according to the calibration result.

### BRIEF DESCRIPTION OF THE DRAWINGS

To more clearly illustrate the technical solutions of the embodiments of the present disclosure, the drawings needed for use in the description of the embodiments will be briefly introduced below. Obviously, the drawings described below are some embodiments of the present disclosure. For those ordinary in the art, other drawings can be obtained based on these drawings without any creative work.

FIG. 1 is a flowchart of a control method of an aerial vehicle consistent with embodiments of the present disclosure.

FIG. 2 is a schematic structural diagram of an aerial vehicle consistent with embodiments of the present disclosure.

FIG. 3 is another schematic structural diagram of an aerial vehicle consistent with embodiments of the present disclosure.

FIG. 4 is another schematic structural diagram of an aerial vehicle consistent with embodiments of the present disclosure.

FIG. 5 is another schematic structural diagram of an aerial vehicle consistent with embodiments of the present disclosure.

FIG. 6 is another schematic structural diagram of an aerial vehicle consistent with embodiments of the present disclosure.

FIG. 7 is a schematic diagram showing interaction consistent with embodiments of the present disclosure.

FIG. 8 is a schematic structural diagram of a quadrotor unmanned aerial vehicle consistent with embodiments of the present disclosure.

FIG. 9 is a flowchart of a control method of a movable platform consistent with embodiments of the present disclosure.

FIG. 10 is another flowchart of a control method of a movable platform consistent with embodiments of the present disclosure.

FIG. 11 is another schematic structural diagram of an aerial vehicle consistent with embodiments of the present disclosure.

FIG. 12 is a perspective structural diagram of region A in FIG. 9.

FIG. 13 is another flowchart of a control method of a movable platform consistent with embodiments of the present disclosure.

FIG. 14 is a schematic structural diagram of a control device consistent with embodiments of the present disclosure.

### DETAILED DESCRIPTION OF THE EMBODIMENTS

Technical solutions in embodiments of the disclosure will be described in conjunction with the accompanying drawings. The described embodiments are some but not all of the embodiments of this application. All other embodiments that those skilled in the art can derive based on the described embodiments without creative effort fall within the scope of the disclosure.

The flowcharts shown in the accompanying drawings are only examples and do not necessarily include all the contents and operations/steps, nor do they have to be performed in the order described. For example, some operations/steps can also be divided, combined, or partially merged, and the actual execution order may change according to actual conditions.

Some embodiments of the present disclosure will be described in detail below in conjunction with the accompanying drawings. The following embodiments and features in the embodiments can be combined with each other when there is no conflict.

Further, some embodiments below are described using movable platform as example, and some embodiments below are described using aerial vehicle as example. Aerial vehicle is an example of movable platform. The embodiments described using aerial vehicle as example can also be generally applied to other types of movable platform (i.e., such embodiments can be generally applied to movable platforms).

An aerial vehicle may transform to switch between multiple states, to perform different functions. The aerial vehicle may perform transformation operations through a transformation mechanism. Since the shape of the aerial vehicle changes during the transformation process, the center of gravity of the aerial vehicle may also change, which may cause the aerial vehicle to be displaced during the transformation process, affecting the control experience.

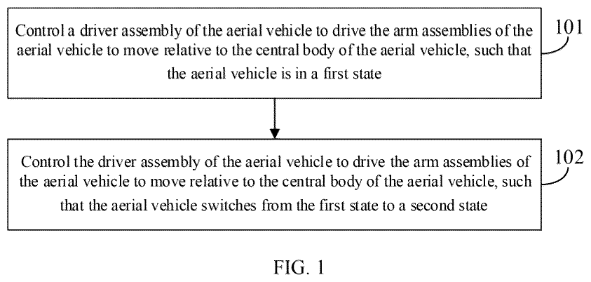

The present disclosure provides a control method of an aerial vehicle to at least partially alleviate the above problems. The aerial vehicle may include a center body 10 and arm assemblies 20. In the examples shown in the figures of the present disclosure, the aerial vehicle includes two arm assemblies 20 located at two sides of the center body 10, respectively. One arm assembly 20 may include a proximal part 211 close to the center body 10 and one or more distal parts 221 away from the center body 10. The arm assembly 20 may be connected to the center body 10 and may be able to move relative to the center body 10. The proximal part 211 may be an end part of the arm assembly 20 that is connected to the center body 10, and the distal part 221 may be an end part of the arm assembly 20 that is farthest away from the center body 10 in a certain direction. In the examples shown in the figures of the present disclosure, one arm assembly 20 includes two distal parts 221. FIG. 1 shows a flowchart of an example control method consistent with the disclosure.

As shown in FIG. 1, at S101, a driver assembly 40 of the aerial vehicle is controlled to drive the arm assemblies 20 of the aerial vehicle to move relative to the center body 10 of the aerial vehicle, such that the aerial vehicle is in a first state (i.e., driving the arm assemblies 20 to put the aerial vehicle in the first state). One arm assembly 20 includes a proximal part close to the center body 10 and a distal part away from the center body 10, and there is an angle between the line connecting the proximal part 211 and the distal part 221 (also referred to as a “connection line”) and the roll axis of the aerial vehicle when the aerial vehicle is in the first state.

At S102, the driver assembly 40 of the aerial vehicle is controlled to drive the arm assemblies 20 of the aerial vehicle to move relative to the center body 10 of the aerial vehicle, such that the aerial vehicle switches from the first state to a second state (i.e., driving the arm assemblies 20 to switch the aerial vehicle from the first state to the second state). The angle is different in the first state and the second state, i.e., the angle changes when the aerial vehicle switches between the first state and the second state.

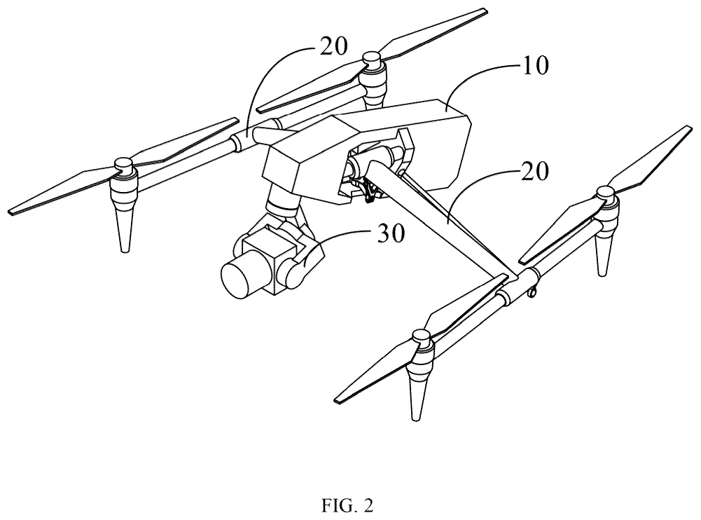

As shown in FIG. 2, in one embodiment, the aerial vehicle may be an unmanned aerial vehicle, and the unmanned aerial vehicle may carry a load 30. An operable space of the load 30 may be adjusted by the movement of the arm assemblies 20. For example, when the load 30 is a photographing device, the operable space of the load 30 may be the field of view (FOV) of the photographing device when photographing. When the load 30 is a spraying device or a sowing device, the operable space of the load 30 may be the spraying or sowing range, which is not limited here.

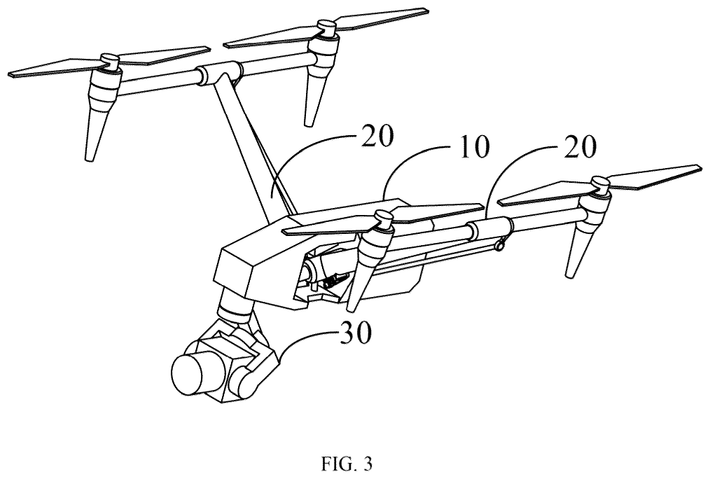

When the load 30 is a photographing device, since the FOV of the photographing device expands outward from the photographing lens, the range of the FOA may be roughly conical, and therefore components farther away from the load 30 may be easier to enter the FOV of the load 30. As shown in FIG. 2 and FIG. 3, the arm assemblies 20 in FIG. 2 are located below the center body 10, and block the field of view of the load 30 rotating around the yaw axis but do not block the field of view of the load 30 rotating around the pitch axis. The arm assemblies 20 in FIG. 3 are located above the center body 10, which block the field of view of the load 30 rotating around the pitch axis but do not block the field of view of the load 30 rotating around the yaw axis.

For the glass-wiping component that rotates up and down and the nozzle component that rotates up and down to spray, the principle is the same. The load 30 of the present disclosure is not limited to the above examples. Those skilled in the art may install the load 30 with certain functions on the center body 10 according to actual needs, such as sensors, transmitters, tools, instruments, manipulators, or other functional devices. Further, the aerial vehicle of the present disclosure may exist independently of the load 30, or it may contain the load 30.

The arm assemblies 20 may be driven by the driver assembly 40 to perform the transformation operation. For example, in one embodiment, the driver assembly 40 may be a motor. The arm assemblies 20 may rotate or move relative to the center body 10 under the drive of the driver assembly 40, and their movable range may be set in advance. For example, the movable range of the arm assemblies 20 may be determined by mechanical limit and/or algorithm limit.

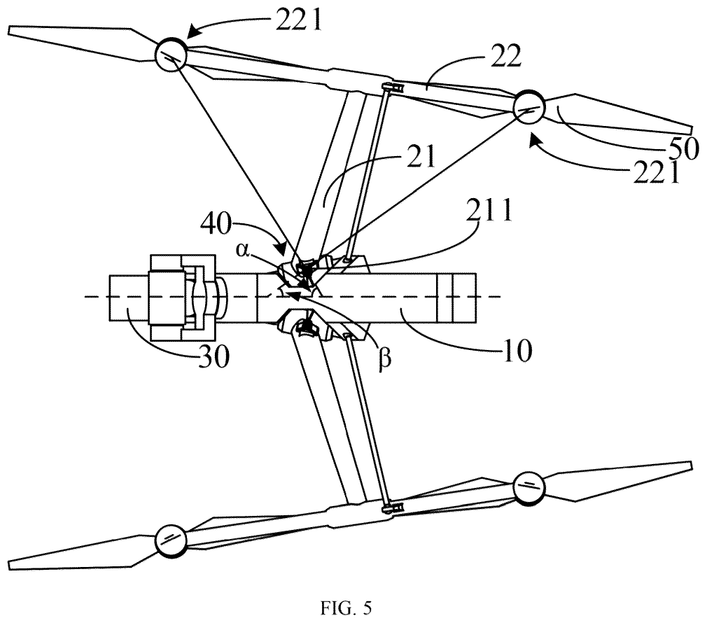

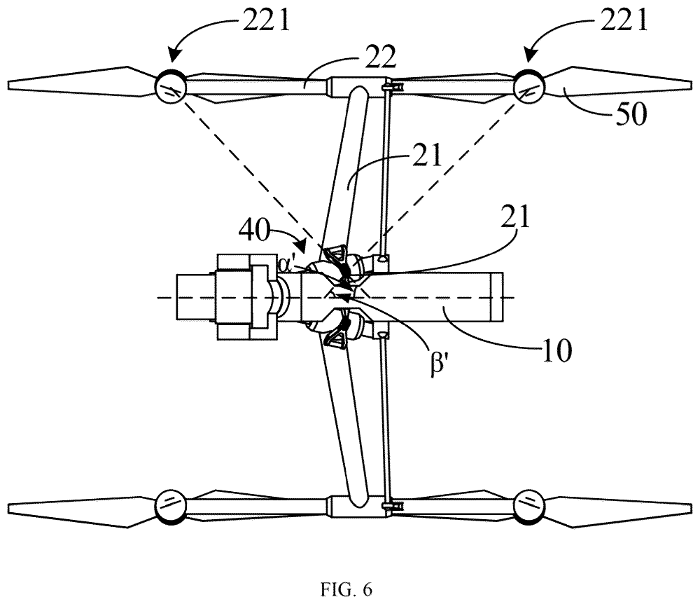

The first state and the second state may be two states when the arm assemblies 20 are located at different positions. For example, the arm assemblies may be located at different heights in the first state and the second state. As shown in FIG. 2 to FIG. 6, the aerial vehicle is in the first state in FIG. 2 and FIG. 5, and in the second state in FIG. 3 and FIG. 6. The arm assemblies 20 may be driven to rotate by the driver assembly 40. When rotating to the first position shown in FIG. 2, cross bars 22 of the arm assemblies 20 may be located below the center body 10. The cross bars 22 of the two arm assemblies 20 may be arranged in a V shape as shown in FIG. 5, and an angle larger than 0° may be formed between the two cross bars. The spacing between the two rotor assemblies 50 at the front end of the aerial vehicle may be different from the spacing between the two rotor assemblies 50 at the rear end. At this time, it may be considered that the aerial vehicle is in the first state. In this disclosure, the two rotor assemblies 50 on a same side of the aerial vehicle, such as two rotor assemblies 50 carried by a same arm assembly 20 in the scenario where one arm assembly 20 carries two rotor assemblies 50, may be referred to as a first rotor assembly 50 and a second rotor assembly 50, respectively, with one being at the front end of the aerial vehicle and the other one being at the rear end of the aerial vehicle. For example, for an aerial vehicle having four the two rotor assemblies 50 at the front end of the aerial vehicle can be the first rotor assemblies 50 and the two rotor assemblies 50 at the rear end of the aerial vehicle can be the second rotor assemblies 50.

When rotating to the second position shown in FIG. 3, the cross bars 22 of the arm assemblies 20 may be located above the center body 10. The cross bars 22 of the two arm assemblies 20 may be arranged roughly in parallel as shown in FIG. 6. The spacing between the two rotor assemblies 50 at the front end of the aerial vehicle may be roughly the same as the spacing between the two rotor assemblies 50 at the rear end, and it may be considered that the aerial vehicle is in the second state. The first position and the second position may be the positions that are commonly used and remain stable when the arm assemblies 20 are in operation. For example, the first position and the second position may be determined by the mechanical limit of the aerial vehicle, or may be determined by the algorithm limit, which is not limited here.

Since the angle between the line connecting the proximal part and the distal part of one arm assembly and the roll axis of the aerial vehicle changes during the process of the aerial vehicle switching between the first state and the second state, the size of the space between the arm assembly and the center body may be adjusted according to the actual application scenario by arm transformation, thereby increasing the operable space of the load 30.

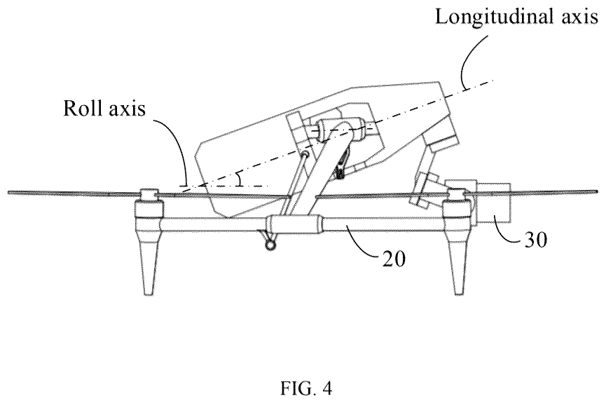

Since one arm assembly 20 is able to rotate relative to the center body 10 when it moves, the angle between the line connecting the proximal part and the distal part of the arm assembly and the longitudinal axis of the center body 10 may be different in the first state and the second state. In this disclosure, the longitudinal axis of the center body 10 refers to, for example, an axis from one end of the center body 10 that is closer to the load 30 to another end of the center body 10 that is farther away from the load 30, i.e., a roll axis of the center body 10, such as the axis shown and marked in FIG. 4. In some embodiments, when the aerial vehicle includes the rotor assembly 50 arranged at the distal part of the arm assembly 20, the angle between the line connecting the rotor assembly 50 and the geometric center point of the center body 10 and the aerial vehicle roll axis in the first state and the second state may also change. In another embodiment, when the aerial vehicle is a four-rotor drone, the angle formed by the lines connecting the two rotor assemblies 50 at the front of the center body 10 and the geometric center point of the center body 10 may also be different in the first state and in the second state. In another embodiment, when the aerial vehicle includes multiple arm assemblies 20, the angle between the extension lines of the multiple arm assemblies 20 may also be different in the first state and in the second state. The above situations may cause the center of gravity of the aerial vehicle to change in the first state and the second state, thereby causing the position drift of the aerial vehicle.

The proximal part 211 of the arm assembly 20 may be an end close to the center body 10, for example, may be located at a position connected to the center body 10. One distal part 221 of the arm assembly 20 may be an end away from the center body 10. In this disclosure, the roll axis of the aerial vehicle refers to, for example, a roll axis of the rotor plane. The roll axis of the aerial vehicle may be an axis parallel to the heading direction, as shown in FIG. 4. When the center body 10 forms a certain angle with the rotor plane, the roll axis of the aerial vehicle may form an angle larger than 0° with the longitudinal axis of the center body 10.

As shown in FIG. 5 and FIG. 6, in one embodiment, the aerial vehicle may include two arm assemblies 20, and one arm assembly 20 may include a connection bar 21 connected to the center body 10 and a cross bar 22 connected to the rotor assembly 50. The connection bar 21 and the cross bar 22 may rotate relative to each other to change the relative position between the arm assembly 20 and the center body 10. The proximal part 211 of the arm assembly 20 may be located at the end position where the connection bar is connected to the center body 10, and the distal part 221 of the arm assembly 20 may be located at the position of the cross bar away from the proximal part 211. Angle α in FIG. 5 and angle α′ in FIG. 6 may be different, and angle 3 in FIG. 5 and angle β′ in FIG. 6 may also be different. In the example shown in FIG. 5 to FIG. 6, the center of gravity of the aerial vehicle may also change accordingly (the center of gravity may move forward or backward), and the aerial vehicle may suddenly move forward or backward during the transformation process, or the picture taken by the aerial vehicle may change greatly, which is not conducive to the control by the user.

To solve the above problem, the aerial vehicle may include a target component, and the spatial position of the target component when the aerial vehicle is in the first state may be substantially the same as the spatial position of the target component when the aerial vehicle is in the second state.

Controlling the spatial position of the target component of the aerial vehicle to remain substantially unchanged in the first state and the second state, may be convenient for the user to perform photographing or control operations during the transformation process, thereby improving the user's experience.

In another embodiment, it may also be possible to control the spatial position of the target component to remain approximately unchanged when switching between the first state and the second state, to further improve the stability of the aerial vehicle during transformation. The method may also include:

S103, controlling the spatial position of the target component of the aerial vehicle to remain approximately unchanged during the process of the aerial vehicle switching between the first state and the second state.

The control method provided in the embodiments of the present disclosure may also be applied to other scenarios where the position of the center of gravity of the aerial vehicle changes significantly, such as when the structural model of the aerial vehicle changes to cause the amount of the position of the center of gravity moving forward/backward to exceed a preset threshold. Alternatively, in some embodiments, the aerial vehicle may also perform the above method when the above-mentioned angle changes and causes the position of the center of gravity of the aerial vehicle to change significantly.

The target component may be a partial structural unit in the aerial vehicle, and its size, dimensions, and function are not limited. The target component may be the default setting when the aerial vehicle leaves the factory, or it may be set by the user. For example, the target component may be located at the load 30 carried by the aerial vehicle, or it may be located at the center body 10, the rotor assembly 50, etc. of the aerial vehicle.

Because of different user requirements for aerial vehicle control, the spatial position of the target component may be set according to actual needs, and the spatial position may be located on the target component or outside the target component.

In some embodiments, the spatial position of the target component may be the spatial position of at least a portion of the target component. For example, when the target component includes the center body 10, the spatial position of the target component may be the spatial position of the geometric center of the center body 10, and the spatial position of the geometric center of the center body 10 may be controlled to remain approximately unchanged, such that the displacement degree of the center body 10 is small when the aerial vehicle is transformed, thereby facilitating user control. In some other embodiments, the spatial position of the target component may also be the spatial position of a portion of the plane where the target component is located. For example, when the target component includes the rotor assemblies 50 of the multi-rotor aerial vehicle, the spatial position of the target component may be the center position of the plane formed by the multiple rotor assemblies 50, and the spatial position of the center of such a plane (also referred to as a “rotor plane”) may be controlled to remain approximately unchanged, such that the displacement of the rotor assemblies 50 is small when the aerial vehicle transforms. It may be set according to the actual application scenario. The spatial position of the target component may be a spatial position in the world coordinate system.

Controlling the spatial position of the target component to remain approximately unchanged may be achieved by controlling the power assembly of the aerial vehicle, for example, by controlling the rotation speeds of the rotor assemblies 50 of the aerial vehicle to balance the change of the center of gravity. Of course, in some other optional embodiments, this may also be achieved by adjusting the angles of the rotor assemblies 50, controlling the driver device of the target component itself, and the like.

The spatial position remaining roughly unchanged may be understood as that the change in spatial position is difficult to detect with naked eyes, or the change in spatial position is less than a preset reference threshold. Such a situation may occur when certain conditions are met, for example, the environmental disturbance factor (such as wind speed) of the aerial vehicle in the air may be small or the aerial vehicle is in an environment without external environmental disturbance (such as a windless environment).

The above method may be performed when the aerial vehicle is in a hovering state. Since the change in the center of gravity of the center body 10 during hovering has a large impact on the displacement of the center body 10, the above method may also be performed only in the hovering state to reduce the impact of the change of the center of gravity caused by the transformation in the hovering state on the control.

In one embodiment, the aerial vehicle may include the rotor assemblies 50, and one rotor assembly 50 may be arranged at the distal part 221 of one corresponding arm assembly 20. The aerial vehicle may be a single-rotor aerial vehicle or a multi-rotor aerial vehicle. As shown in FIG. 5, which is a schematic structural diagram of a quad-rotor aerial vehicle, in one embodiment, the aerial vehicle includes four rotor assemblies 50, which are respectively arranged at the four distal parts 221 of the arm assemblies 20.

The two arm assemblies 20 may be arranged in an “H” shape as shown in the figures, such as FIG. 6, and each arm assembly 20 may include a connection bar 21 connected to the center body 10 and a cross bar 22 connected to the connection bar 21. The rotor assembly 50 may be arranged at the end position of the cross bar 22, that is, at the distal part 221 of the arm assembly 20. When the aerial vehicle performs a transformation operation, the rotor assemblies 50 located at the two ends of one same cross bar may move together with the cross bar 22. Of course, in other optional embodiments, the aerial vehicle may also include four arm assemblies 20, and the four arm assemblies 20 may be respectively connected to the center body 10. The four rotor assemblies 50 may be respectively arranged at the distal parts 221 of the four arm assemblies 20.

In some embodiments, the target component may include at least one of the center body 10, the rotor assemblies 50, or the load 30 carried by the aerial vehicle, to adapt to different control requirements. For example, in one embodiment, when the target component includes multiple components, the spatial position associated with one component may be controlled to remain approximately unchanged, or the multiple components may be simultaneously controlled such that the spatial positions associated with the multiple components remain approximately unchanged, which is not limited here.

Further, in some embodiments, when the target component includes the center body 10, S103 may include:

S1031, controlling the spatial position of the central component of the center body 10 to remain approximately unchanged, and/or controlling the spatial position of the geometric center of the center body 10 to remain approximately unchanged.

By controlling the spatial position associated with the center body 10 to remain approximately unchanged, the spatial position of the entire center body 10 may be kept approximately unchanged when the arm assemblies 20 of the aerial vehicle are moving, and the position of the entire aerial vehicle may be prevented from drifting and affecting the stability of the aerial vehicle.

In some embodiments, when the target component includes the rotor assemblies 50, S103 may include:

S1033, controlling the spatial positions of the rotor assemblies 50 to remain approximately unchanged, and/or controlling the spatial position of the center point of the plane formed by the multiple rotor assemblies 50 to remain approximately unchanged.

When the aerial vehicle is a single-rotor aerial vehicle, the spatial position of the rotor itself may be controlled to remain approximately unchanged during the transformation process. When the aerial vehicle is a multi-rotor aerial vehicle, to facilitate control, the spatial position of the center point of the plane formed by the multiple rotor assemblies 50 may be controlled to remain approximately unchanged. By controlling the spatial position associated with the rotor assemblies 50 to remain approximately unchanged, the position of the rotor assemblies 50 may be kept approximately unchanged when the arm assemblies 20 of the aerial vehicle are moving, and the problem of the rotor assemblies 50 being displaced and causing collisions or affecting the user's perception may be avoided.

In some embodiments, when the target component includes the load 30 carried by the aerial vehicle, S103 may include:

S1034, controlling the spatial position of the functional component of the load 30 to remain approximately unchanged, and/or controlling the spatial position of the geometric center of the load 30 to remain approximately unchanged.

The load 30 may be the above-mentioned photographing device, cleaning device, spraying or spreading device, etc. The functional component of the photographing device may be a lens, and the functional component of the cleaning device may be a brush head or a nozzle, etc. By controlling the spatial position associated with the load 30 carried by the aerial vehicle to remain approximately unchanged, the load 30 may still be able to operate normally during the transformation process of the aerial vehicle, thereby improving the operating efficiency and the user's experience. Further, the aerial vehicle may also control the attitude of the load 30 to remain unchanged during the transformation process to further ensure the normal operation of the load 30.

In some embodiments, when the load 30 is a photographing device, the photographing device may be connected to the aerial vehicle through a gimbal, to achieve rotation in multiple degrees of freedom through the gimbal. The method may also include:

S104, in the process of the aerial vehicle switching between the first state and the second state, controlling the captured image of the photographing device to remain approximately unchanged. For example, the spatial position and attitude of the photographing device may be controlled to keep the captured image roughly unchanged, thereby ensuring that the image captured during the transformation process only changes slightly and improving the photographing effect.

In some embodiments, to facilitate the control of the spatial position of the target component, various positions related to the aerial vehicle may be calibrated by establishing a coordinate system. At the same time, by calibrating the coordinate changes of the arm assembly 20 in the two states, the changes in the center of gravity of the aerial vehicle in the two states may be determined. In this way, when the center of gravity changes, the spatial position of the target component may be kept constant by controlling the spatial position of a certain coordinate point or coordinate area to remain approximately unchanged.

In some embodiments, S103 may include:

S1035, in the process of the aerial vehicle switching between the first state and the second state, the coordinates of a preset coordinate point and/or coordinate area of the aerial vehicle are controlled to remain approximately unchanged. The preset coordinate point and/or coordinate area may be located at the target component.

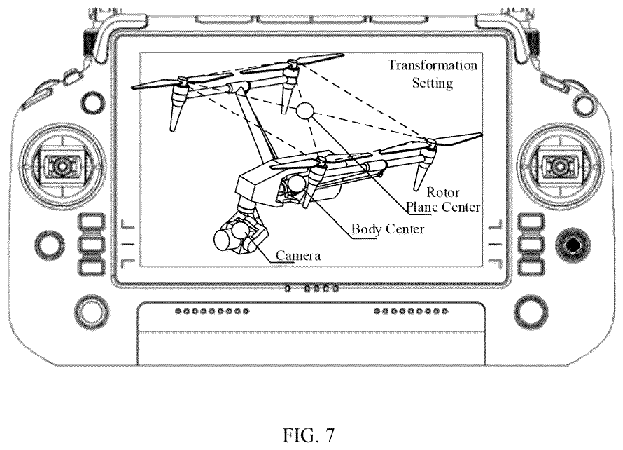

The preset coordinate point and/or coordinate area may be set by the user's input operation to adapt to the different needs of the user. For example, the user may determine the corresponding target component through the input operation on the control terminal. As shown in FIG. 7, which is a schematic diagram showing a display interface of the control terminal, the interaction point may be a coordinate point or coordinate area that the user can select. The user may determine the corresponding target component by clicking the interaction point on the display interface of the control terminal. Of course, in other optional embodiments, the user may also determine the target component by dragging the interaction point or selecting the interaction box, which is not limited here.

In one embodiment, the aerial vehicle may control the output of power devices to keep the spatial position of the target component roughly unchanged.

FIG. 8 is a schematic structural diagram of an unmanned aerial vehicle with four rotors, in which o is the center of gravity, l₁ and l₂ are the long and short axis arms, θ₁ and θ₂ are the front and rear angles, and k is a constant. The four motors with different rotation speeds may generate four different forces F, and generate torques Mₓ, M_{y}, and M_{z} on the x-axis, y-axis, and z-axis, and a total pulling force Lift. This model is called a dynamic model. The equation is:

$$[ \begin{matrix}{M}_{x} \\ {M}_{y} \\ {M}_{z} \\ Lift\end{matrix} ] = [ \begin{matrix}- {l}_{1} sin ( \frac{{θ}_{1}}{2} ) & {l}_{1} sin ( \frac{{θ}_{1}}{2} ) & {l}_{2} sin ( \frac{{θ}_{2}}{2} ) & - {l}_{2} sin ( \frac{{θ}_{2}}{2} ) \\ {l}_{1} cos ( \frac{{θ}_{1}}{2} ) & {l}_{1} cos ( \frac{{θ}_{1}}{2} ) & - {l}_{2} cos ( \frac{{θ}_{2}}{2} ) & - {l}_{2} cos ( \frac{{θ}_{2}}{2} ) \\ {l}_{1} & - {l}_{1} & {l}_{2} & - {l}_{2} \\ k & k & k & k\end{matrix} ] [ \begin{matrix}{F}_{1} \\ {F}_{2} \\ {F}_{3} \\ {F}_{4}\end{matrix} ] .$$

It can be seen from the above figure and the above equation that by changing the output (embodied as the rotation speed) of the rotor assemblies 50, the position and attitude of the aerial vehicle may be changed. Therefore, by controlling the rotation speeds of the rotor assemblies 50, the spatial position of the target component may be controlled to remain approximately unchanged.

In some embodiments, the aerial vehicle may include power devices. One power device may be connected to one corresponding arm assembly 20, and may include a driver motor and a rotor assembly 50. The driver motor may be connected to the rotor assembly 50 to drive the rotor assembly 50 to rotate.

In some embodiments, S103 may include:

S1036, in the process of the aerial vehicle switching between the first state and the second state, controlling the driver motor to change the output rotation speed when driving the rotor assembly 50, such that the spatial position of the target component of the aerial vehicle remains approximately unchanged.

In some embodiments, the aerial vehicle may control the output speed of the driver motor according to the position and/or position change amount of the arm assembly 20 during the activity.

In some embodiments, during the process of the aerial vehicle switching between the first state and the second state, S103 may include:
S1037, during the process of the aerial vehicle switching between the first state and the second state, according to the position and/or position change of the arm assembly 20, controlling the driver motor to change the output speed when driving the rotor assembly 50, such that the spatial position of the target component of the aerial vehicle remains approximately unchanged.

In one embodiment, a sensor may be provided at the aerial vehicle, and the position and/or position change of the arm assembly 20 may be detected by the sensor. In some embodiments, the proximal part 211 of the arm assembly 20 of the aerial vehicle may be provided with a Hall sensor, and the rotation angle of the arm assembly 20 may be detected by the Hall sensor in conjunction with a magnetic ring. In some embodiments, the sensor may also be provided at the driver assembly 40 that drives the arm assembly 20 to move, which is not limited here.

In some embodiments, according to the position and/or position change of the arm assembly 20, S1037 may include:
S10371, determining the center of gravity of the aerial vehicle according to the position and/or position change of the arm assembly 20; and
S10372, controlling the driver motor to change the rotation speed output by the driver motor when driving the rotor assembly 50 according to the position and/or position change of the center of gravity of the aerial vehicle, such that the spatial position of the target component of the aerial vehicle remains approximately unchanged.

In one embodiment, during the transformation, the center of gravity may be obtained by interpolation according to the transformation angle of the arm assembly 20 and the pre-calibrated result, and then the basic structural parameters of the unmanned aerial vehicle may be obtained in real time. The dynamic model may be dynamically solved to linearly compensate for the power difference between the front and rear motors according to the forward and backward movement of the center of gravity. For example, when the center of gravity moves forward during the transformation process, the two rotors located in the front of the center body 10 may be controlled to accelerate, and the rear two rotors may be controlled to decelerate, to balance the acceleration caused by the forward movement of the center of gravity. The acceleration and/or deceleration ratio may be related to the change in the center of gravity.

The position and/or position change of the arm assembly 20 may be obtained in real time, to ensure that the rotation speed output by the driver motor may be controlled according to the real-time change of the center of gravity to compensate for the acceleration caused by the change of the center of gravity during the transformation process.

Therefore, the aerial vehicle may adjust the rotor rotation speed according to the real-time change of the center of gravity during the transformation process, to ensure that the spatial position of the target component remains substantially unchanged to a large extent during the transformation process, and improve the stability of the hovering of the aerial vehicle during the transformation process.

In some scenarios, a movable platform, for example, an aerial vehicle (such as any example aerial vehicle described in this disclosure), may achieve switching between multiple states by transformation to match different functions. In one transformation mode, the movable platform may perform transformation operation through a transformation mechanism. Sensors set on the transformation mechanism may be affected by the activity of the transformation mechanism, resulting in inaccurate parameters obtained. Therefore, there is an urgent need for a method that may calibrate the sensor parameters in real time during the transformation of the movable platform.

The present disclosure also provides a control method for a movable platform, to at least partially alleviate the above problems. The movable platform may be an aerial vehicle (such as an unmanned aerial vehicle), a ground mobile vehicle, a surface mobile vehicle, or other platforms. In the present disclosure, an unmanned aerial vehicle is used as an example for detailed description.

In the control method of the movable platform, the movable platform may include a center body 10, arm assemblies 20 and a plurality of first sensors 23. One arm assembly 20 may be connected to the center body 10 and may move relative to the center body 10. The plurality of first sensors 23 may be disposed on the arm assemblies 20 to realize the movement control of the movable platform, and the relative pose between the plurality of first sensors 23 may change with the activity of the arm assemblies 20.

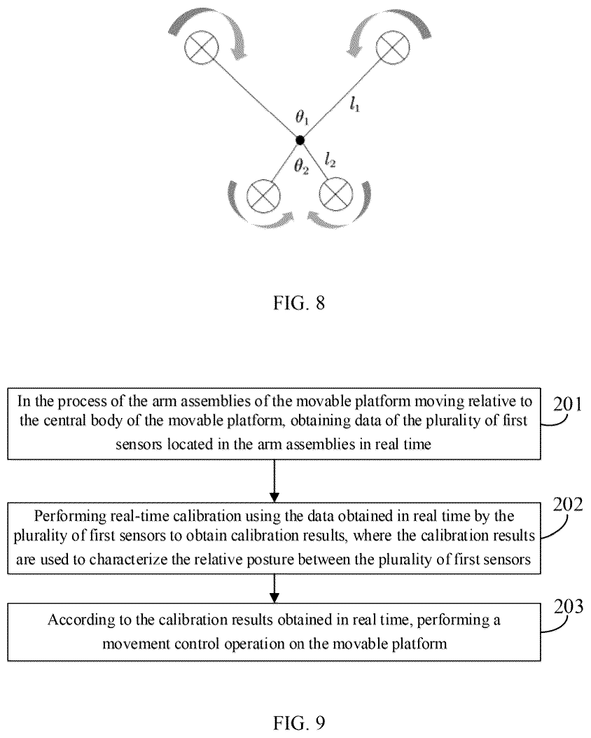

As shown in FIG. 9, in one embodiment, the method includes:

S201, in the process of the arm assemblies of the movable platform moving relative to the center body of the movable platform, obtaining data of the plurality of first sensors located in the arm assemblies in real time;

S202, performing real-time calibration using the data obtained in real time by the plurality of first sensors to obtain calibration results, where the calibration results are used to characterize the relative pose between the plurality of first sensors; and

S203, according to the calibration results obtained in real time, performing a movement control operation on the movable platform.

The plurality of first sensors 23 may be sensors for realizing the movement control function of the movable platform, which may include multiple sensors of the same or different types that realize the same function. For example, in some embodiments, the plurality of first sensors 23 may include distance measuring sensors, and the surrounding environment parameters of the movable platform may be determined by the cooperation between the plurality of distance measuring sensors, to realize path planning or obstacle avoidance operation. In some other embodiments, the plurality of first sensors 23 may include a laser sensor and a vision sensor, and the path planning or obstacle avoidance operation may be realized by the fusion positioning of the laser sensor and the vision sensor. Of course, in other embodiments, the plurality of first sensors 23 may also include an inertial sensor and/or a speed sensor, etc., for obtaining the current state of the movable platform, which is not limited here.

The relative pose of the plurality of first sensors 23 may be the relative pose of the same type of first sensors 23 among the plurality of first sensors 23, or the relative pose of different types of first sensors 23 among the plurality of first sensors 23, which may be set according to the actual application scenario, which is not limited here.

During the movement of the arm assemblies 20, the data obtained by the plurality of first sensors 23 may be affected by the change of the pose of the plurality of first sensors 23. Therefore, it may be needed to calibrate the plurality of first sensors 23 on the arm assemblies 20 in the movement state to correct the data obtained by the plurality of first sensors 23. The corrected data may be used to realize the movement control operation of the movable platform, which may improve the accuracy of the movement control.

Also, since the positions of the arm assemblies 20 changes in real time during the movement, the pose of the plurality of first sensors 23 may also change in real time. Therefore, it may be needed to use the data of the plurality of first sensors 23 for real-time calibration, and the calibration results obtained by the real-time calibration may be used to correct the data obtained by the plurality of first sensors 23, such that the movable platform is able to use the corrected data to perform the movement control operation more accurately.

The control method provided in the present disclosure may be executed by the movable platform itself, or by a control terminal in communication with the movable platform, which is not limited here.

In some embodiments, the movement of the arm assemblies 20 relative to the center body 10 may be actively driven by the driver assembly 40. The driver assembly 40 may drive the arm assemblies 20 to move in the first state and the second state as described above. The driving process may be triggered by user input or automatically by the movable platform.

In some embodiments, the movable platform may include a driver assembly 40, which is connected to the center body 10 and the arm assemblies 20 respectively. The driver assembly 40 may be used to drive the arm assemblies 20 to move relative to the center body 10.

In the process of the driver assembly 40 driving the arm assemblies 20, the relative pose between the plurality of first sensors 23 may change, and the data of the plurality of first sensors 23 may be obtained in real time. In some embodiments, S201 may include:

S2011, when the driver assembly 40 drives the arm assemblies 20 to move, obtaining the data of the plurality of first sensors 23 on the arm assemblies 20 in real time.

The types of the plurality of first sensors 23 may be set according to actual needs, and may specifically include at least one of a vision sensor, a GPS sensor, an inertial sensor, an infrared sensor, a magnetic sensor, an ultrasonic sensor, or a Lidar sensor.

The movable platform may perceive the external environment by combining the image data obtained by a plurality of vision sensors, and the image data may need to be corrected according to the relative pose between the plurality of vision sensors. In some embodiments, the plurality of first sensors 23 may include the plurality of vision sensors, and the data obtained by the plurality of first sensors 23 may include data obtained by the plurality of vision sensors.

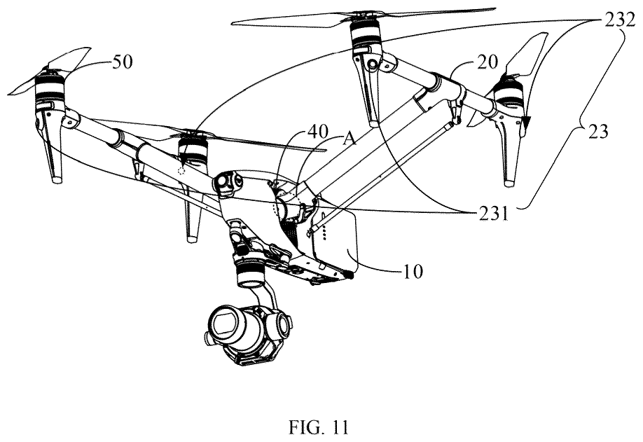

In one embodiment, the plurality of first sensors 23 may include binocular vision sensors. As shown in FIG. 11, in one embodiment, the aerial vehicle shown in FIG. 11 may include two pairs of binocular vision sensors: a pair of first binocular vision sensors 231 located at the front end of one arm assembly 20 and a pair of second binocular vision sensors 232 located at the rear end of one arm assembly 20. The binocular vision sensor may perform feature point match by obtaining images, identify the depth information in the image, and then detect the surrounding environment. The arm assembly 20 may move relative to the center body 10, such that the relative pose of the binocular vision sensors located on the arm assembly 20 changes with the movement of the arm assembly 20. Since the binocular vision sensors needs to be positioned according to the relative pose between the two vision sensors, it may be needed to obtain the image data respectively obtained by the binocular vision sensors in real time, and use the image data to determine the calibration results.

In some embodiments, S202 may correspondingly include:

S2021, using the image data obtained in real time by the binocular vision sensors to calibrate the relative pose parameters between the binocular vision sensors in real time.

The vision sensors may collect multiple images at different poses, and track and match feature points through the obtained image data to determine the pose of the vision sensors. The binocular vision sensors may determine the relative pose between the binocular vision sensors through the obtained image data, and may determine the relative pose change between the binocular vision sensors through multiple image data, such that the relative pose parameters between the binocular vision sensors may be calibrated in real time based on the multiple image data.

In some embodiments, the image data obtained by the binocular vision sensors may be an image sequence obtained frame by frame. In this way, the frame-by-frame change of the relative pose parameters between the binocular vision sensors may be obtained according to the image sequence arranged frame by frame, that is, the real-time calibration of the binocular vision sensors may be realized.

Further, in some embodiments, the calibration results may be determined by using the epipolar constraint and the depth constraint. The epipolar constraint of the current frame of the binocular vision sensors may be determined by the current image frame obtained by the binocular vision sensors respectively. The depth constraint of the current frame of one vision sensor may be determined by the multi-frame image sequence obtained by one of the binocular vision sensors. The accuracy of the calibration results may be further improved by the constraints constructed in real time.

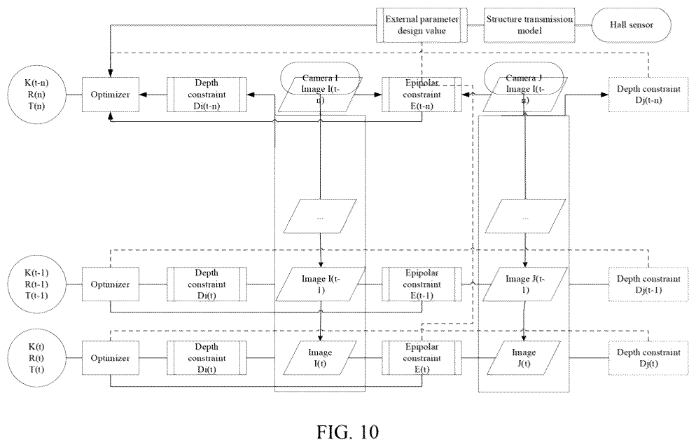

As shown in FIG. 10, in one embodiment, the binocular vision sensor camera I and camera J may obtain an image frame sequence frame by frame. The epipolar constraint of the current frame image may be determined by using the current frame images I(t) and J(t) obtained by the binocular camera I and camera J respectively. The depth constraint of the 2D point of the pixel coordinate system corresponding to the current frame image may be calculated by using the image frame sequence I(t-n)˜I(t−1) or J(t-n)˜J(t−1) obtained by camera I or camera J. Threfore, for any frame, the current depth constraint and epipolar constraint may be obtained through the binocular image of the current frame and the monocular multi-frame image sequence, to determine the calibration results in real time, which may avoid the calibration result of each frame from being calculated through the binocular image frame sequence. The amount of data required for the calibration result calculation may be reduced, improving the calculation efficiency.

The method of obtaining the depth constraint of the current frame from the image sequence may include but is not limited to that the monocular vo/vio/slam system obtains sparse spatial three-dimensional points, or any monocular sparse depth map (dense depth) method.

In some embodiments, in one embodiment, the calibration results may be determined with the assistance of calculating the theoretical pose data of the plurality of first sensors 23. In some embodiments, the method may further include, before the real-time calibration is performed using the data obtained in real time by the plurality of first sensors 23:

S204, during movement of the arm assembly 20, obtaining theoretical pose data of the plurality of first sensors 23 on the moving arm assembly 20 in real time. The calibration results may be determined by gradually converging with the theoretical pose data of the plurality of first sensors 23 as initial values.

Further, the theoretical pose data of the plurality of first sensors 23 may be determined based on the real-time position of the arm relative to the center body 10. For example, in one embodiment, the theoretical pose data of one first sensor 23 may be determined by using the real-time position of the arm assembly 20 when it is moving and the preset structural transmission model of the aerial vehicle.

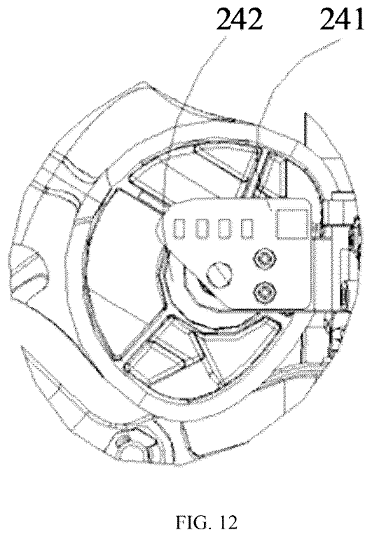

In some embodiments, as shown in FIG. 11 and FIG. 12, a second sensor 24 may be provided at the arm assembly 20 or the center body 10, and the second sensor 24 may be used to obtain the position of the arm assembly 20 in real time, thereby determining the real-time position data of the binocular vision sensor.

In some embodiments, in one embodiment, the arm assembly 20 may move relative to the center body 10 by rotating, and the second sensor 24 may include an angle detection sensor.

Exemplarily, as shown in FIG. 12, when the arm assembly 20 moves relative to the center body 10 by rotating, the second sensor 24 may include an angle detection sensor, for example, a Hall sensor 241 in combination with a magnetic ring 242. The rotation angle of the arm assembly 20 may be obtained by the second sensor 24, and the positions of the binocular vision sensors may be calculated by using the preset structural transmission model of the aerial vehicle, thereby further determining the relative pose between the binocular vision sensors.

In some embodiments, the theoretical pose data of the first sensor 23 may also be used as the initial value or reference value of the epipolar constraint to further improve the accuracy of the calibration result.

After obtaining the calibration results, it may be equivalent to determining the relative pose parameters between the binocular vision sensors. According to the relative pose parameters, the image data obtained by the binocular vision sensors may be corrected to perform movement control operations using more accurate image data, thereby reducing the impact of binocular parallax on the accuracy of the image data obtained by the binocular vision sensor.

In some embodiments, S203 may include:
S2031, correcting the image data obtained in real time by the binocular vision sensors according to the calibration results obtained in real time; and
S2032, using the corrected image data to perform the movement control operation on the movable platform.

The movement control operation may include but is not limited to at least one of an obstacle avoidance operation, a path planning operation, or a target tracking operation.

Since the obstacle avoidance operation has high requirements for data accuracy, in some embodiments, the corrected image data may be used to perform the obstacle avoidance operation to reduce accidents caused by binocular parallax during obstacle avoidance and improve the safety and stability of the movable platform.

For example, in one embodiment, the plurality of first sensors 23 may include a binocular vision sensor, and the movement control operation may include the obstacle avoidance operation, the method may include S1 to S7.

At S1, when the arm assembly 20 is in a movement state, the image sequence is obtained frame by frame by the binocular vision sensors located on the arm assembly 20.

At S2, the images of the current frame of the binocular vision sensors are used to calculate and construct the binocular epipolar constraint, the multi-frame image sequence obtained by one of the binocular vision sensors is used to calculate and construct the depth constraint, and the binocular epipolar constraint and depth constraint are used to calculate the calibration results, that is, the rotation and translation relationship of the camera coordinate system between the binocular vision sensors.

At S3, the calibration results are used to correct the original images collected by the binocular vision sensors. After correction, the two images of the same frame may be located in the same plane and parallel to each other, and each row of pixels in the image may be collinear.

Assuming that the epipolar lines of the binocular image after binocular correction are completely parallel and the focal length is f, the distance between their projection centers is called the baseline.

At S4, feature point extraction is performed on each frame of the image according to the region of each object on the image (ROI, Region of Interest), using methods including but not limited to feature point detection methods such as Harris, SIFT (Scale-Invariant Feature Transform), SURF (Speeded Up Robust Features), or ORB (Oriented FAST and Rotated BRIEF).

At S5, the depth of the feature points of the current frame image is calculated to obtain an image with depth information, where the relative distance between the movable platform and the obstacle may be obtained through the depth information.

At S6, the feature points between the previous and next frames of the image sequence are tracked to calculate the motion of the feature points (optical flow), and then the relative speed between the obstacle and the movable platform is calculated.

At S7, the obstacle avoidance operation is performed based on the relative distance between the movable platform and the obstacle and/or the relative speed between the movable platform and the obstacle.

Therefore, when the binocular vision sensors are set on the arm assembly and the arm assembly is in a movement state, the binocular vision sensors may be calibrated in real time, and the obstacle avoidance operation may be performed according to the images corrected by the calibration results.

The above method may be applied not only to the scene where the arm assembly 20 is driven by the driver assembly 40 to move relative to the center body 10. The method may also be applied to the scene where the arm assembly 20 is connected to the center body 10 and is subject to external forces or environmental factors during the movement of the movable platform. For example, when the movable platform is a ground mobile platform, the above method may be performed in a scene where the road surface is bumpy, the movable platform suddenly accelerates or decelerates, or the relative pose between the binocular vision sensors is easy to change. When the movable platform is an aerial vehicle, the above method may be performed in the scene where the ambient wind speed is large or the attitude of the aerial vehicle changes greatly.

Of course, the above method may also be applied to the scene where the distance between the binocular vision sensors is long (long baseline), and/or the connection structure between the binocular vision sensors is a non-rigid structure (such as a plastic arm/bracket) which causes the binocular vision sensors to change relative pose during the operation of the movable platform. Furthermore, the above method may also be applied to the scene where the binocular vision sensors are located on different movable platforms to solve the problem of real-time change of the relative pose of the binocular vision sensors.

Through the above method, the binocular vision sensors may be set on a movable or long-baseline, non-rigid structure, which expands the application scenario of the binocular vision sensors and the detection range of the binocular vision sensors.

In some embodiments, the binocular vision sensors may not be able to determine the relative pose parameters based on the image data. For example, in a weak texture image or a low-light image, the image data obtained by the binocular vision sensors may not be able to extract feature points, and thus the relative pose cannot be determined based on the feature point tracking and recognition method. In such a case, the effect of automatic obstacle avoidance may be poor. To avoid accidents, the obstacle avoidance operation may be stopped, or a prompt message may be output to remind the user, to reduce the accident rate.

Accordingly, when the movement control operation includes the obstacle avoidance operation, performing the movement control operation using the corrected image data, includes:
when the images obtained by the binocular vision sensors meet a preset failure condition, the obstacle avoidance operation is stopped and/or a prompt message is output.

The failure condition may include any one of: the image is a textureless image; the image is a weak texture image; or the image is a low-light image. Textureless images and weak texture images may be images whose color/grayscale changes are less than a preset threshold. Low-light images may be images taken when the aerial vehicle detects that the amount of incoming light is low, or images whose image brightness is less than a preset threshold determined by the aerial vehicle root recognition.

In a movable platform that performs a transformation operation through the arm assembly 20, since the arm assembly 20 is movably connected to the center body 10, the arm assembly 20 may be displaced by an external force, and the arm assembly 20 may deviate from the original preset position, which may affect the stability and safety of the movable platform due to inaccurate position.

To solve the above problems, one embodiment of the present disclosure provides another control method for a movable platform. The movable platform may include a center body 10, a driver assembly 40 and an arm assembly 20. The arm assembly 20 may be connected to the center body 10 and to the driver assembly 40, and may move relative to the center body 10 under the drive of the driver assembly 40.

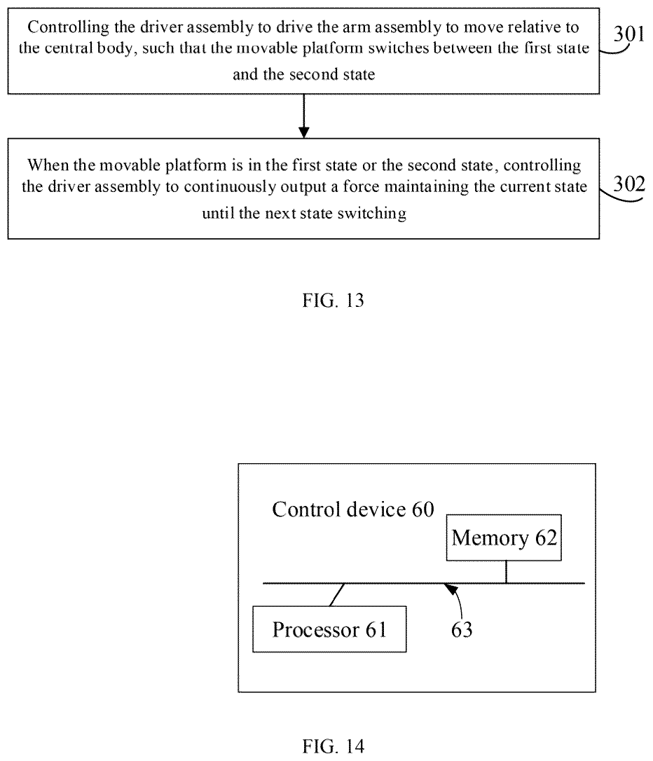

As shown in FIG. 13, the method may include:

S301, controlling the driver assembly 40 to drive the arm assembly 20 to move relative to the center body 10, such that the movable platform switches between the first state and the second state; and

S302, when the movable platform is in the first state or the second state, controlling the driver assembly 40 to continuously output a force maintaining the current state until the next state switching.

For the transformation mode, the first state and the second state of the movable platform, reference can be made to the illustrations and descriptions of the above embodiments, which will not be repeated here.

Therefore, the arm assembly 20 may maintain or restore the arm assembly 20 to the current state when the position is changed by external force, which improves the stability of the arm assembly 20, and also avoids the problem that the arm assembly 20 cannot move to the preset position due to the position change of the arm assembly 20 after being subjected to external force.

In some embodiments, controlling the driver assembly 40 to drive the arm assembly 20 to move relative to the center body 10 such that the movable platform switches between the first state and the second state, may include at least one of:
controlling the driver assembly 40 to drive the arm assembly 20 to move in the first direction to the first position such that the movable platform is in the first state; or
controlling the driver assembly 40 to drive the arm assembly 20 to move in the second direction to the second position such that the movable platform is in the second state.

The first position may be different from the second position, and the first direction may be different from the second direction.

As shown in FIG. 2 and FIG. 3, the arm assembly 20 is in the first position and the movable platform is in the first state in FIG. 2, and, the arm assembly 20 is in the second position and the movable platform is in the second state in FIG. 3.

Since the first state and the second state may be two common and stable states of the movable platform, in some embodiments, the arm assembly 20 may be limited by mechanical limit in the first position and the second position.

In some embodiments, when the movable platform is in the first state or the second state, controlling the driver assembly 40 to output the force that prevents the movable platform from switching to another state, may include at least one of:
when the arm assembly 20 moves to the first position, controlling the driver assembly 40 to continue to output the force that causes the arm assembly 20 to move in the first direction, such that the arm assembly 20 remains in the first position; or
when the arm assembly 20 moves to the second position, controlling the driver assembly 40 to continue to output the force that causes the arm assembly 20 to move in the second direction, such that the arm assembly 20 remains in the second position.

The first position and the second position may be mechanical limit positions of the arm assembly 20.

In some embodiments, to avoid damage to the mechanical structure caused by excessive driving force, when the movable platform is in the first state or the second state, the force output by the driver assembly 40 to maintain the current state may be less than the force output by the driver assembly 40 to drive the arm assembly 20 to move such that the movable platform switches between the first state and the second state.

In some embodiments, the state of the arm assembly 20 may be determined by obtaining data information of the sensor or the driver assembly 40, thereby determining the output of the driver assembly 40 in the current state. The state of the arm assembly 20 may be the position, movement speed or movement acceleration of the arm assembly 20, which are not limited here.

In some embodiments, the movable platform may also include a second sensor 24 which is arranged on the center body 10 and/or the arm assembly 20, and the second sensor 24 may be used to detect the position of the arm assembly 20. The method may also include:
based on the data information of the second sensor 24 and the data information of the driver assembly 40, determining the state of the arm assembly 20.

In some embodiments, the second sensor 24 may include at least one of a vision sensor, a GPS sensor, an inertial sensor, an infrared sensor, a magnetic sensor, an ultrasonic sensor, or a lidar sensor.

In some embodiments, when the arm assembly 20 is rotatably connected to the center body 10, the second sensor 24 may be a Hall sensor, which realizes the position detection of the rotation angle by cooperating with the magnetic ring.

In some embodiments, the driver assembly 40 may include a servo, and the data information of the driver assembly 40 may include the number of rotations of the servo.

The present disclosure also provides a control device. As shown in FIG. 14 which is a schematic block diagram showing the structure of a control device, in one embodiment, the control device may be applied to the aforementioned aerial vehicle or movable platform. The control device may be integrated into the aforementioned aerial vehicle or movable platform, or may be independently set and communicate with the aerial vehicle or movable platform. The aforementioned control method may also be applied to the control device.

As shown in FIG. 14, in one embodiment, the control device 60 may include a processor 61 and a memory 62. The processor 61 and the memory 62 may be connected through a bus 63, where the bus 63 is, for example, an I2C (Inter-integrated Circuit) bus.

The processor 61 may be a micro-controller unit (MCU), a central processing unit (CPU) or a digital signal processor (DSP), etc.

The memory 62 may be a flash chip, a read-only memory (ROM) disk, an optical disk, a U disk or a mobile hard disk, etc.

The control device 60 may be applied to an aerial vehicle. The aerial vehicle may include a center body 10 and an arm assembly 20. The arm assembly 20 may include a proximal part 211 close to the center body 10 and a distal part 221 away from the center body 10. The arm assembly 20 may be connected to the center body 10 and move relative to the center body 10. The processor 61 may be used to execute a computer program stored in the memory 62, and, when executing the computer program, to implement: controlling the driver assembly 40 of the aerial vehicle to drive the arm assembly 20 to move relative to the center body 10 of the aerial vehicle, such that the aerial vehicle is in a first state, where the arm assembly 20 includes a proximal part 211 close to the center body 10 and a distal part 221 away from the center body 10, and when the aerial vehicle is in the first state, there is an angle between the line connecting the proximal part 211 and the distal part 221 and the roll axis of the aerial vehicle; or
controlling the driver assembly 40 of the aerial vehicle to drive the arm assembly 20 to move relative to the center body 10 of the aerial vehicle, such that the aerial vehicle switches between the first state and the second state, where the angles are different in the first state and the second state.

In another embodiment, the control device 60 may be applied to a movable platform. The movable platform may include a center body 10, an arm assembly 20 and a plurality of first sensors 23. The arm assembly 20 may be connected to the center body 10 and may move relative to the center body 10. The plurality of first sensors 23 may be arranged on the arm assembly 20. The processor 61 may be used to execute a computer program stored in the memory 62, and, when executing the computer program, to implement: in the process of the arm assembly 20 of the movable platform moving relative to the center body 10 of the movable platform, obtaining data of the plurality of first sensors 23 located in the arm assembly 20 in real time, where the plurality of first sensors 23 are used to realize the movement control of the movable platform and the relative poses between the plurality of first sensors 23 may change with the movement of the arm assembly 20 relative to the center body 10; performing real-time calibration using the data obtained in real time by the plurality of first sensors 23 to obtain calibration results, wherein the calibration results are used to characterize the relative poses between the plurality of first sensors 23; and performing a movement control operation on the movable platform according to the calibration results obtained in real time.

In the example shown in FIG. 14, one processor 61 and one memory 62 are depicted and the embodiments described above use one processor 61 and one memory 62 as an example. In other embodiments, the control device 60 can include more than one processor 61 and/or more than one memory 62, which collaborate to perform a method consistent with the disclosure, such as any example methods described above.

The present disclosure also provides an aerial vehicle. The aerial vehicle may include a center body and an arm assembly. The arm assembly may include a proximal part portion close to the center body and a distal part portion away from the center body. The arm assembly may be connected to the center body and may move relative to the center body. The aerial vehicle may also include a control device. The control device may include: a memory for storing a computer program; and a processor for executing the computer program to implement the control method of the aerial vehicle provided by various embodiments of the present disclosure.

The present disclosure also provides a movable platform. The movable platform may include a center body, an arm assembly and a plurality of first sensors. The arm assembly may be connected to the center body and may move relative to the center body. The aerial vehicle may also include a control device. The control device may include: a memory for storing a computer program; and a processor for executing the computer program to implement the control method of the movable platform provided by various embodiments of the present disclosure.

The detail implementation method can refer to the above method embodiments, and will not be repeated here to avoid repetition.

The technicians in the relevant field may clearly understand that for the convenience and simplicity of description, the specific working process of the control system described above may refer to the corresponding process in the above control method embodiments, and will not be repeated here.

The present disclosure also provides a computer-readable storage medium. The computer-readable storage medium may be configured to store a computer program. The computer program may include program instructions, and a processor may execute the program instructions to implement any control method provided by various embodiments of the present disclosure.

The computer-readable storage medium may be an internal storage unit of the aerial vehicle or movable platform described in any of the above embodiments, such as a hard disk or memory of the aerial vehicle or movable platform. The computer-readable storage medium may also be an external storage device of the aerial vehicle or movable platform, such as a plug-in hard disk equipped on the aerial vehicle or movable platform, a smart media card (SMC), a secure digital (SD) card, a flash card (Flash Card), etc.

The terms used in the present disclosure are only for the purpose of describing specific embodiments and are not intended to limit the scope of the present disclosure. As used in the present disclosure and the appended claims, unless the context clearly indicates otherwise, the singular forms of “a,” “an,” and “the” are intended to include plural forms.

The term “and/or” used in the present disclosure and the appended claims refers to any combination of one or more of the associated listed items and all possible combinations, and includes these combinations.

Various embodiments have been described to illustrate the operation principles and exemplary implementations. Those skilled in the art would understand that the present disclosure is not limited to the specific embodiments described herein and there can be various other changes, rearrangements, and substitutions. Thus, while the present disclosure has been described in detail with reference to the above described embodiments, the present disclosure is not limited to the above described embodiments, but may be embodied in other equivalent forms without departing from the spirit and scope of the present disclosure.

What is claimed is:

1. A control method comprising:
obtaining, in real time during operation of a movable platform, data of a plurality of sensors located at one or more arm assemblies of the movable platform;
performing real-time calibration using the data to obtain a calibration result that characterizes a relative pose between the plurality of sensors; and
performing movement control on the movable platform according to the calibration result.

2. The method according to claim 1, wherein:
obtaining, in real time during operation of the movable platform, the data of the plurality of sensors includes obtaining, in real time during a process of the one or more arm assemblies moving relative to a center body of the movable platform, the data of the plurality of sensors; and
the plurality of sensors are arranged such that the relative pose between the plurality of sensors is able to change during the process of the one or more arm assemblies moving relative to the center body.

3. The method according to claim 1, wherein:
the one or more arm assemblies include two arm assemblies; and
the plurality of sensors include two vision sensors arranged at the two arm assemblies, respectively, and the calibration result characterizes a relative pose between the two vision sensors.

4. The method according to claim 3, wherein:
the two vision sensors are two first vision sensors arranged at front ends of the two arm assemblies, respectively; and
the plurality of sensors further include two second vision sensors arranged at rear ends of the two arm assemblies, respectively, and the calibration result further characterizes a relative pose between the two second vision sensors.

5. The method according to claim 1, wherein the plurality of sensors include one or more of a vision sensor, a GPS sensor, an inertial sensor, an infrared sensor, a magnetic sensor, an ultrasonic sensor, or a Lidar sensor.

6. The method according to claim 1, wherein the plurality of sensors include a vision sensor, and the data includes image data obtained by the vision sensor.

7. The method according to claim 1, wherein the vision sensor includes a binocular vision sensor, and the data includes image data respectively obtained by vision sensors forming the binocular vision sensor.

8. The method according to claim 7, wherein performing real-time calibration using the data includes performing real-time calibration on a relative pose parameter of the vision sensors forming the binocular vision sensor using the image data obtained in real time by the binocular vision sensor.

9. The method according to claim 8, wherein the image data obtained in real time by the binocular vision sensor includes an image sequence obtained frame by frame.

10. The method according to claim 9, wherein:
performing real-time calibration to obtain the calibration result includes using epipolar constraint and depth constraint to determine the calibration result;
the epipolar constraint is based on current frames respectively obtained by the vision sensors of the binocular vision sensors; and
the depth constraint is based on a image sequence obtained frame by frame by at least one of the vision sensors of the binocular vision sensor.

11. The method according to claim 7, wherein performing movement control on the movable platform includes:
correcting the image data according to the calibration result to obtain corrected image data; and
performing movement control on the movable platform according to the corrected image data.

12. The method according to claim 1, wherein obtaining, in real time during operation of the movable platform, the data of the plurality of sensors includes obtaining, in real time during a process of a driver assembly of the movable platform driving the one or more arm assemblies to move relative to a center body of the movable platform, the data of the plurality of sensors.

13. The method according to claim 1, further comprising, before performing real-time calibration:
obtaining, in real time during operation of the movable platform, theoretical pose data of the plurality of sensors;
wherein performing real-time calibration to obtain the calibration result includes gradually converging with the theoretical pose data as an initial value to determine the calibration result.

14. The method according to claim 13, wherein the theoretical pose data is determined based on a real-time position of the one or more arm assemblies relative to a center body of the movable platform.

15. The method according to claim 14, wherein:
the plurality of sensors are a plurality of first sensors;
the movable platform further includes one or more second sensors arranged at the one or more arm assemblies and/or the center body; and
the real-time position of the one or more arm assemblies is obtained by the one or more second sensors.

16. The method according to claim 15, wherein the one or more arm assemblies are configured to rotate relative to the center body, and the one or more second sensors include an angle detection sensor.

17. The method according to claim 16, wherein the one or more second sensors include a Hall sensor.

18. The method according to claim 1, wherein the movement control includes at least one of an obstacle avoidance operation, a path planning operation, or a target tracking operation.

19. A control device comprising:
one or more memories storing one or more computer programs; and
one or more processors configured to execute the one or more computer programs to:
obtain, in real time during operation of a movable platform, data of a plurality of sensors located at one or more arm assemblies of the movable platform;
perform real-time calibration using the data to obtain a calibration result that characterizes a relative pose between the plurality of sensors; and
perform movement control on the movable platform according to the calibration result.

20. An aerial vehicle comprising:
one or more arm assemblies;
a plurality of sensors located at the one or more arm assemblies; and
a control device including:
one or more memories storing one or more computer programs; and
one or more processors configured to execute the one or more computer programs to:
obtain, in real time during operation of the movable platform, data of the plurality of sensors;
perform real-time calibration using the data to obtain a calibration result that characterizes a relative pose between the plurality of sensors; and
perform movement control on the movable platform according to the calibration result.
